(19) United States
(12) Patent Application Publication
(10) Pub. No.: US 2002/0089806 A1
(43) Pub. Date: Jul. 11, 2002

(54) Digital interface of an electrostatic power supply and turbine speed controller

(75) Inventors: John Bennett Hamilton, Mount Airy, MD (US); John Hamilton Long, Woodbine, MD (US)

Correspondence Address: LEONARD BLOOM & ASSOCIATES, LLC, Intetllectual Property Law Offices, 401 Washington Avenue, Suite 905, Towson, MD, 21204, US

(73) Assignee: EFC SYSTEMS, INC.

(21) Appl. No.: 09/755,790

(22) Filed: Jan. 5, 2001

(51) Int. Cl. H05B 1/00

(52) U.S. Cl. 361/227

(57) ABSTRACT

A method and apparatus for controlling components used in the application of a coating incorporates digital communications and improved signal verification into the coating process. The method consist of sending data from one or more controllers to a controlled device, such as an electrostatic power supply, turbine speed controller or other coating device, and receiving data therefrom over a digital data link. The data sent to the controlled device may include any control parameters, including activating the controlled device to perform an intended function or instructions that tell the controlled device what to do. The data which may be returned from the controlled device includes various status information. Where the controlled device is a power supply, the method further incorporates a cross-checking function, to prevent accidental activation. The coating apparatus includes a device for spraying a paint, powder, or other type of coating in a controlled manner onto a receiving surface. An array of structures and forms of digital communication are contemplated, but in all cases include a digital communications link between controller and coating apparatus.

### CROSS REFERENCE TO RELATED APPLICATION

This application incorporates by reference the entire contents of commonly-owned application Ser. No. 09/405,550 filed Sep. 24, 1999 and entitled “METHOD AND APPARATUS FOR CONTROLLING POWER SUPPLIED TO AN ELECTROSTATIC DEVICE” and for the teachings therein regarding a digitally controlled electrostatic power supply.

### BACKGROUND OF THE INVENTION

1. Field of the Invention

This invention pertains generally to the field of coating application. More specifically, the present invention incorporates a digital data communications link into a coating apparatus, for the improved dispensing of a coating product.

2. Description of the Related Art

Modern painting systems include an array of controls which are designed to enhance the quality of a coated product. The success and quality of application of coating materials is determined by a large number of variables, including such physical parameters as the horizontal and vertical positions of the spray nozzle or applicator, and the speed of motion of the applicator relative to the work surface. Other variables may include the numbers of passes a gun makes over a given area, the intervals between when a given area has coating material applied, the distance between the spray nozzle and the work surface, the spray pattern, and the pressure of the coating material and any propellant at the time of discharge towards the work surface, among others.

As if these variables are not enough, each paint and, where used, propellant or carrier, will also have a unique set of characteristics. The viscosity of the coating material and propellant, the effects of temperature and humidity, the coalescing characteristics of droplets of the fluid, and the content or composition of the material with regard to such factors as electrical conductivity in the case of electrostatic coating devices, and solvent content or volatility are all contributors to the proper conditions and rates of application.

As is evident, there are a large number of variables that can affect the quality and consistency of a coating. Nevertheless, with knowledge of a particular coating or paint, this information may be applied to the application process to control the parameters of the coating machine, and, where possible, the coating environment. For example, a high-viscosity material may require greater discharge pressures to adequately atomize the material into a fine mist for smooth coatings than would be required for a low viscosity material.

With appropriate software programming of a programmable controller, selected information about a particular coating material, and the intended coating characteristics, an operator may more quickly apply a high quality coating than if the characteristics were to be determined through actual trial and error. Furthermore, where an investment has been made in robotic control, the movements of the applicator or spray gun may be much more precisely controlled through a program than through manual control. This type of programmable control may also provide the added benefit of improving or expanding the capabilities of the painting system, since some types of coatings and/or change-overs from one type of coating material to another may not otherwise be economically practical. When a manual machine is set for a particular coating, the change-over labor and cost of test work pieces is prohibitive.

In order to provide programmable control of a coating system, physically separated components must then have a communications link between the controller and the device. Signals have heretofore been transmitted through communications links using analog signal lines by either varying low voltage signals, such as continuously variable zero-to-ten volt signal lines, or through current loop interfaces that operate between zero and twenty milliamperes. However, because the environment surrounding a painting system and the physical layout associated therewith is uncontrolled, there is a requirement for calibration with each system, depending upon such factors as the type of cabling and distance between devices. There is also a possibility for extraneous electrical or electromagnetic interference (EMI) with the analog system. Even some of the components found in most typical paint systems will generate EMI, including various turbines, compressors, relays and other similar devices. This type of environment, which for the purposes of this disclosure will be termed an industrial environment, is prone to large amounts of EMI that can lead, quite unpredictably, to substantial signal degradation. In fact, the current loop interface has as one benefit somewhat greater resistance to signal degradation than the voltage counterpart, particularly over relatively long distances. When a control or sensor signal is degraded, unpredicted events may occur. If a control system receives sensor data indicating a large deviation from intended, corrective action may be falsely dictated, and the coating incorrectly applied. With precision coatings, this can lead to a complete rejection of not only the coating, but in many cases a loss of the work piece as well. Since the coating will often be applied relatively late in the manufacturing process of a work piece, the reduction of manufacturing yields at this late stage in manufacturing can have significant economic impact to the entire manufacturing operation.

One example of such systems is illustrated by Ooishi et al in U.S. Pat. No. 4,723,726 the teachings of which are incorporated herein by reference. Ooishi et al describes a rotary type electrostatic spray painting device that includes an electronic control unit, a rotary shaft driven by an air turbine, and a sensor for measuring the rotary speed of the air turbine. The sensor generates an analog frequency indicative of the rotary speed, and then this speed is converted to an analog voltage. This analog voltage is then transmitted through the industrial environment to an analog-to-digital converter which is located within the electronic control unit. Signals emanating from the control unit are sent to the peripheral components through an output port as a current value representing the control value. Nevertheless, and as aforementioned, this type of control system is highly susceptible to EMI within the environment. Furthermore, the amount of information that may be exchanged over a current loop or voltage line is extremely limited.

Falcoff, in U.S. Pat. No. 4,614,300 also incorporated herein by reference, also discloses a computerized paint spray machine. In Falcoff, a microcomputer is programmed to store various paint spraying procedures. Nevertheless, nothing is provided to improve the interface between a controller and the controlled components.

The prior art fails to beneficially address the needs of the industrial environment, and, as has been observed in the industry, a certain amount of product is undesirably accepted as scrap. What is needed then is a method and apparatus which provides better communication with remote components.

### SUMMARY OF THE INVENTION

In a first manifestation, the invention is an apparatus for the controlled atomization and propulsion of a durable coating to a work product. The apparatus is resistant to EMI and does not require the usual calibration of analog systems. It includes a controller having a central processing unit, a peripheral controllable unit for adjusting the application of coating to work product, and a digital interface between the controller and peripheral controllable unit. The central processing unit has an input, an output and a means for processing program instructions and responsive thereto providing a digital signal through the output. The peripheral controllable unit also has an input, an output and a means for processing program instructions and responsive thereto providing a digital signal through the output. The digital interface couples the central processing unit output to the peripheral controllable unit input through an indeterminate but finite distance, and transmits a digital signal from controller to peripheral controllable unit.

In a second manifestation, the invention is a digital interface for providing direct digital point to point communication within a controllable painting system. A controller and slave device each have a digital communications port, and a digital interface couples the controller communications port to the slave device communications port through an indeterminate but finite distance. Digital words are transmitted from said controller to said peripheral controllable unit through said digital interface.

In a third manifestation, the invention is a networked communications system for interconnecting a plurality of separately housed robot controllers, a plurality of separately housed electrostatic power supplies and a turbine speed controller. A plurality of digital robot controller interfaces, a plurality of digital electrostatic power supply interfaces and a digital communications network couple the plurality of robot controllers with the digital electrostatic power supplies through an indeterminate finite distance. A graphical user interface is coupled to the digital communications network for displaying information representative of the status of at least one the plurality of digital robot controller and for altering the data contained within the digital robot controller.

### OBJECTS OF THE INVENTION

A first object of the invention is to provide a means for transferring more information between a coatings controller and physically separate components. A second object of the invention is to provide the information transfer in a way which is relatively more immune to EMI and other issues commonplace in an industrial environment. A third object of the invention is to enable more complex communication between various peripheral devices. Another object of the invention is to provide feedback to a person regarding the operation and status of the interconnected components. Yet another object of the invention is to provide remote, off-site monitoring, control and troubleshooting of the system. An additional object of the invention is to provide additional safety features which were not available in the prior art. These and other objects are achieved in the present invention, which may be best understood by the following detailed description and drawing of the preferred embodiment.

### BRIEF DESCRIPTION OF THE DRAWINGS

FIG. 1 illustrates by block diagram the major components of a preferred embodiment that has been designed in accord with the teachings of the invention.

### DESCRIPTION OF THE PREFERRED EMBODIMENT

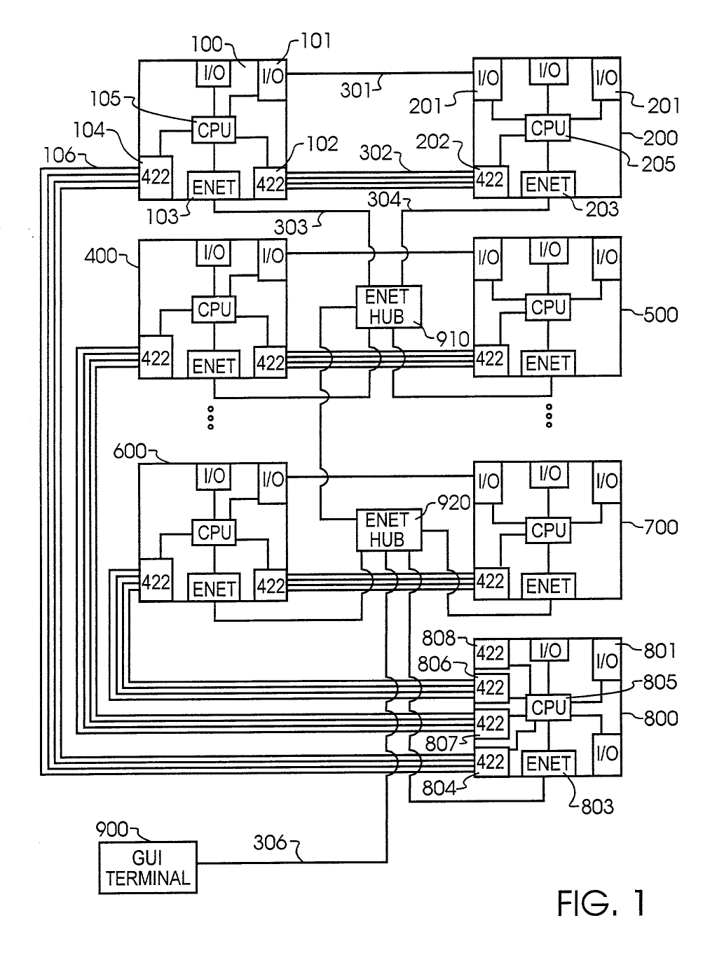

A preferred embodiment digital interface system for use in combination with a coating system 100 is illustrated by block diagram in FIG. 1. A robot controller 100 includes one or more I/O (input/output) ports 101, which in the preferred embodiment may provide basic communications through line 301 to other separately packaged and physically remote devices. In the most preferred embodiment, line 301 provides communication with a digital electrostatic power supply 200, which is also most preferably provided with a corresponding I/O port 201. Robot controller 100 will also most preferably include a second interface 102, which might, for example, include hardware and software protocols compliant with the RS-422 industry standards. Interface 102 may also provide communication between robot controller 100 and digital electrostatic power supply 200, which will be discussed in greater detail hereinbelow. An additional RS-422 compliant interface 104 is most preferably provided which interconnects through a wiring harness 106 directly with a similarly RS-422 compliant interface in the digital quad turbine speed controller 800. An additional digital interface is most preferably provided from robot controller 100 through an Ethernet type interface 103. Interface 103 provides a communications channel between robot controller 100 and Ethernet hub 910, thereby ensuring communications through the Ethernet with other devices connected to the Ethernet.

Robot controller 100 will most preferably also incorporate some type of processor, such as digital Central Processing Unit (CPU) 105. This CPU 105 will most preferably include an integrated circuit type microprocessor. The microprocessor is provided with program instructions that are stored in some type of memory, typically in Electrically Erasable Programmable Read Only Memory (EEPROM), Flash memory, or other non-volatile storage medium. Most preferably, this program may be readily modified or adjusted, in accord with changes that are dictated by other components of the system or through operator input or with system upgrades, though the program may also be fixed in non-volatile memory that is not alterable, such as in ROM or PROM. CPU 105, in association with the programmed operations stored in memory, may be instructed to monitor and control a plurality of functions and feed status information to peripheral and associated devices through the various ports 101-104. Typically, CPU 105 will also be provided with sufficient addressable Random Access Memory (RAM) to be able to store data and results during the actual processing of program instructions. Further peripheral devices are well-known in the microprocessor art that may be required for implementation in the preferred embodiment, but these may depend upon the exact manufacturer and type of device selected, and the extent of capabilities desired for the particular application. These peripheral devices, RAM, ROM and microprocessor will most preferably be located on a common circuit board or otherwise in close proximity to each other to reduce cost, readily permit high speed communication and reduce the probability for extraneous interference. Although not illustrated, a power source will typically be provided which is capable of providing a well-regulated source of power to the various components, as is known in the electronics art. Additional components may be provided within robot controller 100, as will be known in the art for additional functions that may be performed by robot controllers, above and beyond the more specific functions detailed herein.

A similar arrangement or construct of components are found within digital electrostatic power supply 200 as are found within robot controller 100, and parts with similar function are numbered with the same two digit suffix. For example, I/O 201 performs a function similar or identical to I/O 101 in facilitating communications over line 301. A very significant difference, however, will be found in the actual program instructions which are used to control CPU 205, compared to those instructions used to control CPU 105. Furthermore, the exact amount of RAM, ROM, specific brands or types of components and other factors inconsequential to the operation of the system are not required to be identical for the proper operation of the digital interface system. Additionally, digital electrostatic power supply 200 will include all components necessary for generating a digitally controlled voltage suitable for use within an electrostatic spraying system. These components will most preferably include digitally controlled voltage sources, various fault detectors and safety features, and sensors and indicators.

In the operation of the most preferred embodiment, robot controller 100 will send data in a digital format to digital electrostatic power supply 200. This data will be received through RS-422 compliant interface 202, and will then be routed to CPU 205. The primary information which will be transmitted from controller 100 to power supply 200 will be information needed to control voltage settings and power output from power supply 200. Data will also be transmitted, in this preferred embodiment, from power supply 200 over transmission lines 302 to controller 100. This data will most preferably include, but not be limited to, such information as the actual output voltage level, any fault conditions that may have been detected, and other similar information.

Most preferably, signal line 301 serves as a second, confirming signal line which confirms the enabling of power supply 200. This prevents any adverse signal condition along a single data transmission path, such as lines 302, from adversely affecting the instructions performed by CPU 205 for this critical function of enabling. In this way, power supply 200 is prevented from inadvertently activating and causing damage to persons and property.

As is apparent from FIG. 1, the preferred embodiment is not limited to a single robot controller 100 and a single digital electrostatic power supply 200, but may include an indeterminate number of such devices, as illustrated by controllers 400, 600 and power supplies 500, 700. The use of additional controllers may be readily accommodated in the workings of the preferred embodiment.

A digital quad turbine speed controller is also most preferably provided, which is interfaced through digital transmission lines such as the exemplary RS-422 ports provided with each robotic controller 100, 400, 600. Once again, components of like function have like two-digit suffixes, with exception of the four RS-422 interfaces, which have been numbered 804, 806, 807 and 808 for convenience. Turbine speed controllers are also known in the art, and the process of digital control and communication will be apparent to those skilled in the field upon review of the present specification. Furthermore, existing analog turbine controllers may be readily retrofit in light of the present specification to provide the necessary digital input and output ports. Existing analog power supplies and controllers may similarly be retrofit in light of the present disclosure.

In a most preferred form of the present invention, additional communications and control may be provided digitally through an Ethernet interface, which will be most preferably provided on each of the various major components 100, 200, 400, 500, 600, 700, 800 and on Graphical User Interface (GUI) 900. The functions and circuitry necessary for the implementation of these Ethernet interfaces are well described in other literature, and will not be reviewed herein. However, GUI terminal 900 offers several features and advantages that are advantageous in the preferred embodiment. More particularly, the use of GUI terminal 900 enables an operator to easily input various programming parameters and instructions directly into the various CPUs within the system. Command and control of each of the controllers and power supplies is thus enabled through the GUI terminal. Where EEPROM or Flash memory is used to store program instructions and parameters, these may similarly be updated through the Ethernet link. The GUI terminal will be programmed to display or provide information to a human operator in a standard human written or auditory language or through readily understandable iconic information. The GUI terminal 900 may be connected through a physical link, such as a wiring harness or cable, or may alternatively be connected through a radio, infrared, telephonic or even satellite link. This alternative connection allows a remote control, testing and operation that can prove to be very valuable in the large scale manufacturing and production environment. As is known, down time can be very costly, and sometimes the remote access can allow a geographically remote but highly skilled person to resolve any issues or to assist in such resolution. Resolution may be through remote activation of various diagnostic procedures, or the uploading and downloading of critical data or program instructions. Remote monitoring and data logging is also readily achievable with the use of GUI 900. New parameters or procedures for new coating materials may even be transmitted through the Ethernet interface from a vendor or remote laboratory or research facility. As with the other major components, it will be readily apparent that more than one GUI 900 may be provided.

While there has been little discussion herein with regard to the physical structure of lines 106, 301, 302, 303, 304 and the other similar lines, it is important to note that these lines may be implemented in a variety of known configurations and hardware, including simple twisted pairs in the preferred embodiment RS-422 configuration, bare wire, shielded co-axial cable, fiber-optic waveguides or cables, Infra-Red (IR) links, or even radio or wireless modem links, as deemed appropriate for the application and environment. The protocols used in the communications channel may include synchronous, asynchronous or isosynchronous communications, and may be based in part or entirely upon the EIA, IEEE, ISO and other standards, such as, but not limited to, the RS-422, RS-232, V.35, RS-530 and other protocols.

To overcome the adverse affects of an industrial environment, the present invention incorporates a digital interface and additionally provides dual activation of particularly critical components such as the power supply enable feature. As will be apparent, the exact arrangement or type of components is not critical to the present invention, and the drawing figure is provided merely as a guide to assist those skilled in the art in the practice of the present invention, as required by the statutes.

Having thus disclosed the preferred embodiment and some alternatives to the preferred embodiment, additional possibilities and applications will become apparent with further discussion. In alternative embodiments, the hardware of the present invention may be applied not only to the most preferred electrostatic paint sprayers, but to any suitable coating machines requiring similar controls and having similar process requirements and limitations, independent of the exact composition or type of material to be coated. The specific applications will dictate the exact hardware most suitable, but will be ascertained by those skilled in the art without undue effort or experimentation. Therefore, while the foregoing details what is felt to be the preferred embodiment of the invention, no material limitations to the scope of the claimed invention are intended. Further, features and design alternatives that would be obvious to one of ordinary skill in the art are considered to be incorporated herein. The scope of the invention is set forth and particularly described in the claims hereinbelow.

I claim:

1. An apparatus for the controlled application of a durable coating to a work product, through the atomization and propulsion of the coating through a distance and into contact with the work product, which is resistant to EMI and which does not require the usual calibration of analog systems, comprising:
a controller having a central processing unit;
a peripheral controllable unit for adjusting the application of said coating to said work product which is separately packaged and physically remote from said controller;
said central processing unit having an input, an output and a means for processing program instructions and responsive thereto providing a digital signal through said central processing unit output;
said peripheral controllable unit having an input, an output and a means for processing program instructions and responsive thereto providing a digital signal through said controllable unit output; and
a digital interface coupled from said central processing unit output to said peripheral controllable unit input through an indeterminate but finite distance for transmitting a digital signal from said controller to said peripheral controllable unit.

2. The apparatus for the controlled application of a durable coating of claim 1, wherein said digital interface additionally couples said central processing unit input to said peripheral controllable unit output for transmission of data.

3. The apparatus for controlled application of a durable coating of claim 1, further comprising a means for spraying said coating through a gaseous medium.

4. The apparatus for the controlled application of a durable coating of claim 3, wherein said spraying further comprises electrostatic spraying.

5. The apparatus for the controlled application of a durable coating of claim 1, further comprising a plurality of controllers and a plurality of peripheral controllable units.

6. The apparatus for the controlled application of a durable coating of claim 1, wherein said controlled unit further comprises an electrostatic power supply.

7. The apparatus for the controlled application of a durable coating of claim 1, wherein said controlled unit further comprises a turbine speed controller.

8. The apparatus for the controlled application of a durable coating of claim 5, wherein said plurality of controlled units further comprise a turbine speed controller and an electrostatic power supply.

9. The apparatus for the controlled application of a durable coating of claim 1, further comprising a graphical user interface for receiving human input and providing said human input to said controller input and said peripheral controllable unit input and receiving output from said controller and said peripheral controllable unit, and processing said received output for display through said graphical user interface.

10. The apparatus for the controlled application of a durable coating of claim 1, wherein said digital interface further comprises a first transmission link for transmitting said digital signal and a second communications link which transmits a signal independently of said first transmission link and which provides a confirmation signal that confirms said digital signal transmitted through said first transmission link.

11. The apparatus for the controlled application of a durable coating of claim 9, wherein said controller is further connected through an Ethernet link to said graphical user interface.

12. The apparatus for the controlled application of a durable coating of claim 1, wherein said digital signal further comprises complex data representing a set of operations to be performed by said peripheral controllable unit.

13. A digital interface for providing direct digital point to point communication within a controllable painting system, comprising:
a controller with a digital communications port;
a slave device with a digital communications port; and
a digital interface coupling said controller communications port to said slave device communications port through an indeterminate but finite distance, for transmitting a digital word from said controller to said peripheral controllable unit through said distance.

14. A networked communications system for interconnecting components of a spray coating apparatus including a plurality of separately housed robot controllers, a plurality of separately housed electrostatic power supplies and a turbine speed controller, comprising:
a plurality of digital robot controller interfaces each within respective ones of said plurality of robot controller housings for communications external to each of said respective robot controller housings;
a plurality of digital electrostatic power supply interfaces within respective ones of said plurality of digital electrostatic power supply housings for communications external to each of said respective digital electrostatic power supply housings;
a digital communications network coupling said plurality of digital robot controller interfaces with said plurality of said digital electrostatic power supply interfaces through an indeterminate finite distance; and
a graphical user interface coupled to said digital communications network for displaying information from said network representative of the status of one of said plurality of digital robot controllers and for altering the data contained within said one of said digital robot controllers.

15. The networked communications system of claim 14 further comprising a communications link distinct from said digital communications network for transmitting confirmation signals, whereby critical system operations may be confirmed prior to implementation.
